(19) United States
(12) Patent Application Publication
(10) Pub. No.: US 2015/0165866 A1
(43) Pub. Date: Jun. 18, 2015

(54) ASPIRATOR IN-CAR SENSOR MODULE FOR VEHICLE, INSTALLATION STRUCTURE OF IN-CAR SENSOR MODULE AND VEHICLE HAVING THE INSTALLATION STRUCTURE

(71) Applicant: Hyundai Motor Company, Seoul (KR)

(72) Inventor: Yong Chul KIM, Hwaseong-si (KR)

(73) Assignee: Hyundai Motor Company, Seoul (KR)

(21) Appl. No.: 14/300,014

(22) Filed: Jun. 9, 2014

(30) Foreign Application Priority Data
Dec. 18, 2013 (KR) 10-2013-0158647

(51) Int. Cl. B60H 1/00

(52) U.S. Cl. CPC B60H 1/00585

(57) ABSTRACT

An aspirator in-car sensor module for a vehicle may include a suction opening that is installed at a position where an air velocity is the highest within a heating, ventilation and air conditioning (HVAC) module of the vehicle, and a discharge opening that is extracted from the HVAC module to be inserted into the HVAC module.

### CROSS-REFERENCE TO RELATED APPLICATION

The present application claims priority to Korean Patent Application No. 10-2013-0158647 filed on Dec. 18, 2013, the entire contents of which is incorporated herein for all purposes by this reference.

### BACKGROUND OF THE INVENTION

1. Field of the Invention

The present invention relates to an aspirator in-car sensor module for a vehicle which is one of an indoor temperature sensor for a vehicle, an installation structure of the in-car sensor module, and a vehicle having the installation structure, and more particularly, to an aspirator in-car sensor module for a vehicle which can increase an air velocity by positioning a suction unit of an in-car sensor module (or an aspirator) at a place where an air flow rate is the highest within a HVAC (heating, ventilation, and air conditioning) module of a vehicle (for example, a place where a cross-section area is the smallest), accurately measure an indoor temperature by inserting a discharge opening of the aspirator in-car sensor module (or the aspirator) into the HVAC module, and prevent the displeasure of a passenger due to the discharge of cool air into the inside, an installation structure of the in-car sensor module, and a vehicle having the installation structure.

2. Description of Related Art

In general, a vehicle is provided with an air conditioning device as an indoor product configured to pleasantly maintain the inside of the vehicle regardless of an external environment and to contribute to safe driving by removing a frost covered on a vehicle window including windshield glass when an external temperature is low as in the event of rain or winter season.

Since the air conditioning device is typically provided with both a heating system and a cooling system, the air conditioning device is configured to heat or cool the inside of the vehicle by selectively introducing external air or internal air, heating or cooling the air, and supplying the air to the inside of the vehicle.

FIG. 1 is a diagram for describing an operational relation and a schematic configuration of an air conditioning device for a vehicle. As illustrated in FIG. 1, an air conditioning device for a vehicle 10 includes a blower unit 18 that has a blower fan 12, a blower motor 14 and a fan case 16 so as to introduce internal air and external air required for cooling and heating, an evaporator that changes the air transferred from the blower unit 18 into cool air by heat exchange using a refrigerant supplied through a compressor, a condenser, a receiver driver, and an expanding valve (all not illustrated), and a heater core 22 that changes ambient air into warm air by heat exchange using high-temperature coolant.

A temperature adjusting door 24 that adjusts a flow ratio of air by appropriately mixing the cool air with the warm air is provided between the evaporator 20 and the heater core 22.

Further, a defrost vent 26, a face vent 28, and a foot vent 30 are formed so as to blow the cool air and the warm air to a predetermined position within a vehicle, and doors 32, 34 and 36 are provided to adjust the air flow ratio of the vents 26, 28 and 30.

Accordingly, the air conditioning device for a vehicle having such a structure introduces the internal air and the external air through the vents 26, 28 and 30 at the adjusted temperature and air flow rate into the inside of the vehicle by selectively introducing the internal air and the external air depending on an manipulation of an air blowing mode switch provided at a predetermined positioned of an instrument panel by a driver.

However, in order to secure safe driving by constructing a more convenient and pleasant driving environment, there is recently a growing trend for systems of all vehicles to be automated and digitalized.

Thus, the distribution of automatic vehicle air conditioning devices is expanded from manual vehicle air conditioning devices. When a driver sets a desired temperature in the automatic air condition device, since air of a temperature appropriate for the set temperature is introduced into the inside of the vehicle, the driver does not pay attention to other things other than driving during the driving of the vehicle, so that the driver can safely drive.

The automatic air conditioning device is divided into a semiautomatic type and a full-automatic type, and a schematic operational relation of the full-automatic air conditioning device will be described below.

The full-automatic air conditioning device is configured to maximize comfortability by appropriately driving various driving units (a blower motor, an air mix door, a mode door, and a switch) on the basis of control logic that is previously set to implement an optimum state desired by the driver and the passenger by allowing a microcomputer to receive input values that constantly changes from various sensors (In-car, Sun, Water, Humidity sensor) and to periodically read the received input values and to allow the driver to focus on the driving by minimizing the manipulation of various switches of a control panel.

An in-car sensor (or a vehicle indoor temperature sensor) among sensors of the automatic air conditioning device is provided, and this in-car sensor 52 measures an air temperature within the vehicle. The in-car sensor is divided into an active in-car sensor provided with a small motor and an aspirator in-car sensor.

The active in-car sensor is configured to suck internal air through the driving of the small motor and to measure a temperature by a temperature sensor, and the aspirator in-car sensor is configured to suck internal air by a pressure difference caused by a flow velocity and to measure a temperature by a temperature sensor. Since the aspirator in-car sensor has low noise and low cost, the aspirator in-car sensor is widely used in the vehicle.

As illustrated in FIG. 2, the aspirator in-car sensor is positioned on an instrument panel (not assigned reference numeral) to which an air conditioning operation panel 40 within the vehicle is attached, and the in-car sensor 52 is generally installed within a penetrating pipe 54 in which an suction hole 56 is formed, as illustrated in FIG. 3.

The penetrating pipe 54 at which the in-car sensor 52 is installed is connected to an aspirator 70 that is provided at one side between the evaporator 20 and the heater core 22 by an aspirator hose 60, for example.

The aspirator 70 is configured to allow internal air to constantly flow near the in-car sensor 52 by generating a negative pressure by a venturi principle by using a blasting pressure within the evaporator 20.

More specifically, a penetrating tube 74 is inserted into a rear surface of an air inlet 72, and the air that has passed through the evaporator 20 is quickly introduced into the penetrating tube 74 through the air inlet 72. In this way, the negative pressure is generated to generate a negative pressure near the suction hole 56, and the internal air is sucked by the suction hole 56, so that the in-car sensor 52 measure a temperature of the internal air.

That is, the aspirator in-car sensor module has a structure that sucks the internal air by the pressure difference, and when an inflow rate of a blower is small due to the structure, since the internal air is less sucked, it is difficult to accurately measure a temperature of the internal air.

Moreover, as illustrated in FIG. 1, when the aspirator 70 is installed at the rear of the evaporator 20, since the cool air may be discharged to the inside, the passenger may feel uncomfortable.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an aspirator in-car sensor module for a vehicle, and an installation structure of the in-car sensor module, and a vehicle having the installation structure having advantages of increasing an air velocity by positioning a suction unit of an in-car sensor module (or an aspirator) at a place where an air velocity is the highest within a HVAC (heating, ventilation, and air conditioning) module of a vehicle (for example, a cross-section area is the smallest), accurately measuring an indoor temperature by inserting a discharge opening of the aspirator into the HVAC module, and preventing the displeasure of a passenger due to the discharge of cool air to the inside.

In an aspect of the present invention, an aspirator in-car sensor module for a vehicle, may include a suction opening that is installed at a position where an air velocity is the highest within a heating, ventilation and air conditioning (HVAC) module of the vehicle, and a discharge opening that is extracted from the HVAC module to be inserted into the HVAC module.

The suction opening and the discharge opening are formed to an end of an aspirator hose mounted to the HVAC module.

In another aspect of the present invention, in an installation structure of an aspirator in-car sensor module for a vehicle, a suction opening of the in-car sensor module is installed at a position where an air velocity is the highest within a heating, ventilation and air conditioning (HVAC) module of the vehicle, and in a discharge opening of the in-car sensor module is inserted into the HVAC module from outside of the HVAC module.

The suction opening and the discharge opening are formed to an end of an aspirator hose mounted to the HVAC module.

The position where the air velocity is the highest within the HVAC module is a place where a cross-section area of the HVAC module is the smallest.

The place where the cross-section area of the HVAC module is the smallest is positioned adjacent to a side portion of a blower fan mounted inside the HVAC module.

In further aspect of the present invention, in a vehicle provided with an aspirator in-car sensor module, a suction opening of the in-car sensor module is installed at a position where an air velocity is the highest within a HVAC (heating, ventilation and air conditioning) module of the vehicle, and a discharge opening of the in-car sensor module is inserted into the HVAC module from outside the HVAC module.

The suction opening and the discharge opening are formed to an end of an aspirator hose mounted to the HVAC module.

The position where the air velocity is the highest within the HVAC module is a place where a cross-section area of the HVAC module is the smallest.

The place where the cross-section area of the HVAC module is the smallest is a side portion of a blower fan mounted inside the HVAC module.

According to the exemplary embodiments of the present invention, it is possible to increase an air velocity by positioning a suction unit of an in-car sensor module at a place where an air flow rate is the highest within a HVAC (heating, ventilation, and air conditioning) module of a vehicle (for example, a place where a cross-section area is the smallest), accurately measuring an indoor temperature by inserting a discharge opening of an aspirator into the HVAC module, and preventing the displeasure of a passenger due to the discharge of cool air to the inside.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic configuration diagram illustrating a general air conditioning device for a vehicle.

FIG. 2 is a perspective view illustrating a state where a general in-car sensor module for a vehicle is installed.

FIG. 3 is a perspective view of a general aspirator in-car sensor module for a vehicle.

FIG. 4 is a diagram illustrating an aspirator sensor module for a vehicle according to an exemplary embodiment of the present invention and an installation structure of the in-car sensor module.

FIG. 5 is a perspective view illustrating an aspirator sensor module for a vehicle according to an exemplary embodiment of the present invention and a part of the installation structure of the aspirator sensor module.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention will be described more fully hereinafter with reference to the accompanying drawings, in which exemplary embodiments of the invention are illustrated. However, the present invention is not limited to the exemplary embodiments described herein, and may be implemented in other forms.

Throughout the specification, unless explicitly described to the contrary, one element including other elements will be understood to imply the inclusion of other elements but not the exclusion of any other elements.

Throughout the specification, the same reference numerals will be used to refer to the same constituent elements. In the drawings, sizes and/or thicknesses of constituent components are magnified to clarify some of constituent components.

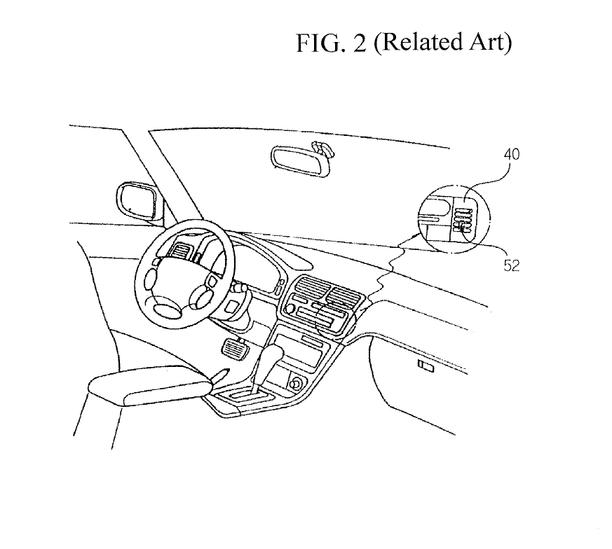

FIG. 2 is a conceptual diagram illustrating an example of a vehicle to which an installation structure of an aspirator in-car sensor module for a vehicle according to an exemplary embodiment of the present invention is applied.

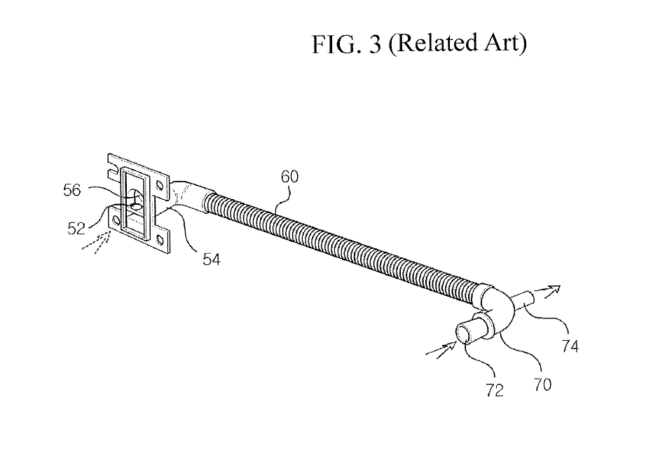

As illustrated in FIG. 2, a vehicle to which an installation structure of an aspirator in-car sensor module 100 according to an exemplary embodiment of the present invention is applied includes an instrument panel to which an air conditioning operation panel 40 within a vehicle is attached, and an in-car sensor 52 (see FIG. 3) according to the exemplary embodiment of the present invention may be provided at the instrument panel or other places.

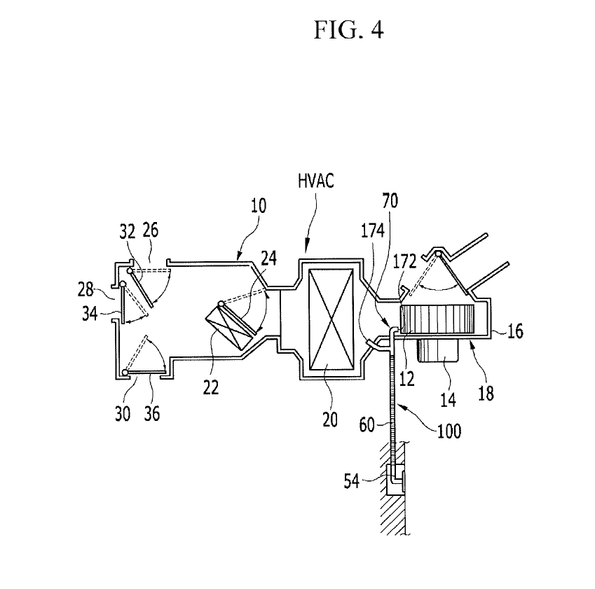

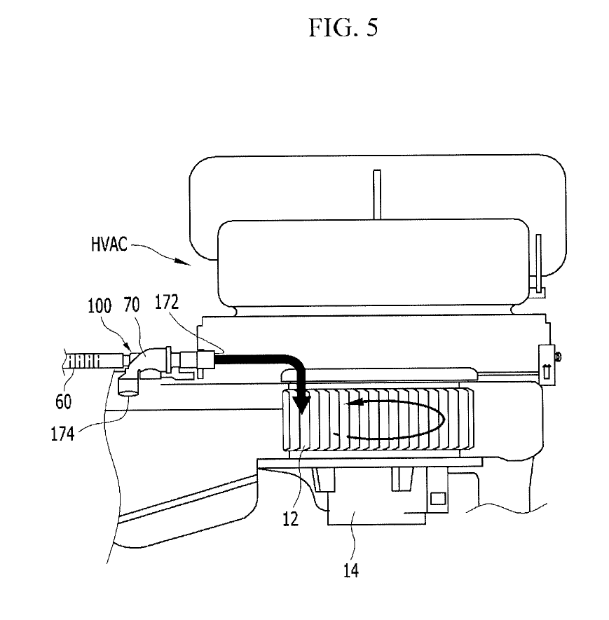

FIG. 4 is a diagram illustrating the installation structure of the aspirator in-car sensor module according to the exemplary embodiment of the present invention, and FIG. 5 is a perspective view illustrating a part of the installation structure of the aspirator in-car sensor module according to the exemplary embodiment of the present invention.

The installation structure of the aspirator in-car sensor module according to the exemplary embodiment of the present invention is an installation structure capable of accurately measuring an indoor temperature even though a driver selects an air flow rate/an air velocity at a low level by installing the aspirator in-car sensor module 100 at a place where the air velocity is the highest within a HVAC module.

The installation structure of the aspirator in-car sensor module 100 according to the exemplary embodiment of the present invention is an structure in which the in-car sensor module 100 or a suction opening 172 of an aspirator 70 is provided at a position where the air velocity is the highest within a HVAC (heating, ventilation and air conditioning) module of the vehicle, for example, a position where a cross-section area of the HVAC is the smallest, and a discharge opening 174 of the in-car sensor module 100 is inserted into the HVAC module from outside the HVAC module.

The position where the air velocity is the highest within the HVAC module is the place where the cross-section area of the HVAC module is the smallest, and is a side portion of a blower fan 12, that is, a position adjacent to the blower fan 12, as illustrated in FIGS. 4 and 5.

The vehicle at which the aspirator in-car sensor module 100 according to the exemplary embodiment of the present invention is installed may be a vehicle illustrated in FIG. 2.

Hereinafter, the aspirator in-car sensor module for a vehicle according to the exemplary embodiment of the present invention, the installation structure of the in-car sensor module, and an operation of the vehicle having the installation structure will be described in detail with reference to the accompanying drawings.

FIG. 4 is a diagram illustrating the installation structure of the aspirator in-car sensor module according to the exemplary embodiment of the present invention, and FIG. 5 is a perspective view illustrating a part of the installation structure of the aspirator in-car sensor module according to the exemplary embodiment of the present invention.

As illustrated in FIGS. 4 and 5, according to the exemplary embodiment of the present invention, in order to maximize performance of an aspirator type in-car sensor (an interior temperature sensor for a vehicle), it is possible to sufficiently secure an air velocity for measuring the indoor temperature of the vehicle even though the driver (or a user) selects an air flow mode in which the air velocity is low by installing the suction unit 172 of the in-car sensor module 100 at the position where the air velocity is the highest within the HVAC module, for example, the position where the cross-section area of the HVAC module is small. Accordingly, according to the installation structure of the present invention, it is possible to accurately measure the indoor temperature of the vehicle.

Moreover, according to the exemplary embodiment of the present invention, in order for the external cool air from the in-car sensor module 100 to be prevented from being discharged into the car, the discharge opening 174 of the aspirator in-car sensor module 100 is inserted into the HVAC module, as illustrated in FIGS. 4 and 5.

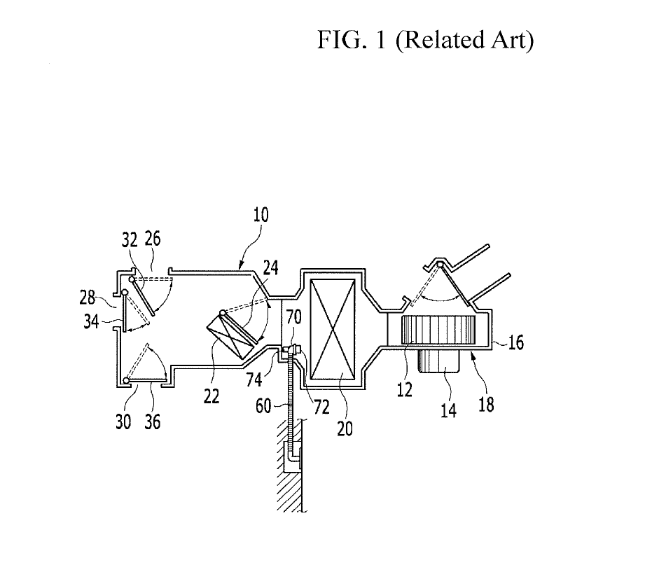

According to such an installation structure, it is possible to ensure suction performance of about three times more than an existing installation structure (for example, FIG. 1), and particularly, since the indoor temperature can be more accurately detected at a low air velocity level that is frequently used by the driver or a passenger, it is possible to improve control performance of the air conditioning device.

The aspirator in-car sensor module 100 applied to the such an installation structure can more accurately measure the indoor temperature than an active in-car sensor module while reducing burden on noise and cost which are drawbacks of an active in-car sensor.

That is, according to the aspirator in-car sensor module for a vehicle according to the exemplary embodiment of the present invention and the installation structure of the in-car sensor module—(when an existing technology is used, since the cross-section area is large even at the same air flow rate, a pressure by an air velocity is slow, and, thus, an air velocity of a sensor unit is relatively slow)—since the cross-section area is small, an air velocity becomes fast, and, thus, an air velocity of the sensor unit becomes fast by about three times. Accordingly, the aspirator in-car sensor module according to the exemplary embodiment of the present invention can accurately measure the indoor temperature with higher performance than the active in-car sensor, and since air is not discharged into the inside, it is possible to solve inconvenience of a customer due to the discharge of the cool air.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An aspirator in-car sensor module for a vehicle, comprising:
a suction opening that is installed at a position where an air velocity is the highest within a heating, ventilation and air conditioning (HVAC) module of the vehicle; and
a discharge opening that is extracted from the HVAC module to be inserted into the HVAC module.

2. The aspirator in-car sensor module for the vehicle of claim 2, wherein the suction opening and the discharge opening are formed to an end of an aspirator hose mounted to the HVAC module.

3. An installation structure of an aspirator in-car sensor module for a vehicle,
wherein a suction opening of the in-car sensor module is installed at a position where an air velocity is the highest within a heating, ventilation and air conditioning (HVAC) module of the vehicle, and
wherein a discharge opening of the in-car sensor module is inserted into the HVAC module from outside of the HVAC module.

4. The installation structure of the aspirator in-car sensor module for the vehicle of claim 3, wherein the suction opening and the discharge opening are formed to an end of an aspirator hose mounted to the HVAC module.

5. The installation structure of the aspirator in-car sensor module for the vehicle of claim 3, wherein the position where the air velocity is the highest within the HVAC module is a place where a cross-section area of the HVAC module is the smallest.

6. The installation structure of the aspirator in-car sensor module for the vehicle of claim 4, wherein the place where the cross-section area of the HVAC module is the smallest is positioned adjacent to a side portion of a blower fan mounted inside the HVAC module.

7. A vehicle provided with an aspirator in-car sensor module,
wherein a suction opening of the in-car sensor module is installed at a position where an air velocity is the highest within a HVAC (heating, ventilation and air conditioning) module of the vehicle; and
wherein a discharge opening of the in-car sensor module is inserted into the HVAC module from outside the HVAC module.

8. The vehicle provided with the aspirator in-car sensor module of claim 7, wherein the suction opening and the discharge opening are formed to an end of an aspirator hose mounted to the HVAC module.

9. The vehicle provided with the aspirator in-car sensor module of claim 7, wherein the position where the air velocity is the highest within the HVAC module is a place where a cross-section area of the HVAC module is the smallest.

10. The vehicle provided with the aspirator in-car sensor module of claim 9, wherein the place where the cross-section area of the HVAC module is the smallest is a side portion of a blower fan mounted inside the HVAC module.
